(19) United States
(12) Patent Application Publication
(10) Pub. No.: US 2025/0159447 A1
(43) Pub. Date: May 15, 2025

(54) DISAGGREGATED APPLICATION ON A RAN CONTROLLED VIA RIC PLATFORM

(71) Applicant: DISH Wireless L.L.C., Englewood, CO (US)

(72) Inventors: Dhaval Mehta, Aldie, VA (US); Siddhartha Chenumolu, Ashburn, VA (US); Sourabh Gupta, Ashburn, VA (US); Sagar Narendrakumar Patel, Dublin, CA (US)

(21) Appl. No.: 18/505,384

(22) Filed: Nov. 9, 2023

(51) Int. Cl. H04W 4/50; H04L 41/0816

(52) U.S. Cl. CPC H04W 4/50; H04L 41/0816

(57) ABSTRACT

A disclosed method may include (i) determining, by a RAN intelligent controller (RIC) of a telecommunications network, a RAN function change, (ii) sending the RAN function change to a disaggregated application that is separate from the RIC, the disaggregated application including a small agent of an application of the RIC, and (iii) causing by the small agent of the application of the RIC, the RAN function change to alter a behavior of one or more of a centralized unit (CU) or a distributed unit (DU). Related systems and computer-readable mediums are further disclosed.

### BRIEF SUMMARY

This disclosure is generally directed to disaggregated applications on Radio Access Network (RAN) controlled via RAN intelligent controller (RIC) platforms in the context of a telecommunications network where the RIC is able to communicate with the disaggregated applications to change the RAN functions. Historically, open radio access network (O-RAN) architecture standards strictly required that applications had to be hosted inside of the RIC platform itself. Using the disaggregated applications that host small agents of the applications separate from the RIC platform provide for intelligent control of portions of applications separate from the RIC platform. This disaggregated application allows for more efficient use of the RIC platform. In one example, a method may include (i) determining, by a RIC of a telecommunications network, a RAN function change, (ii) sending the RAN function change to a disaggregated application that is separate from the RIC, the disaggregated application including a small agent of an application of the RIC, and (iii) causing by the small agent of the application of the RIC, the RAN function change to alter a behavior of one or more of a centralized unit (CU) or a distributed unit (DU).

In one example, the RIC is a non-real time RIC and the RAN function change is a delayed tolerant function change.

In one example, the small agent is a controller of a non-real time RIC application, and the controller is separate from the one or more of the CU or DU.

In one example, the small agent is a controller of a non-real time RIC application, and the controller is included within the one or more of the CU or DU.

In one example, the RIC as a near-real time RIC and the RAN function change is a time-sensitive function change.

In one example, the small agent is an agent of a near-real time RIC application, and the agent is separate from the one or more of the CU or DU.

In one example, the small agent is an agent of a near-real time RIC application, and the agent is included within the one or more of the CU or DU.

This application also further discloses a non-transitory computer-readable medium encoded with instructions that, when executed by a physical processor of a computing device, cause the computing device to perform the method of one or more embodiments of the method outlined above.

This application also further discloses a system configured to perform one or more of the embodiments outlined above.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings.

FIG. 1 shows an example open radio area network architecture including a real time RIC and a near-real time RIC.

FIGS. 2A and 2B show examples of a disaggregated application on a non-real time RIC.

FIGS. 3A and 3B show examples of a disaggregated application on a near-real time RIC.

FIG. 4 shows a flowchart of an example method of a disaggregated application on a RAN controlled via a RIC platform.

FIG. 5 shows a system diagram that illustrates an example computing system that implements and/or comprises one or more components of a system that implements a disaggregated application on a RAN controlled via RIC.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current disclosure. The phrases “in one embodiment,” “in another embodiment,” “in various embodiments,” “in some embodiments,” “in other embodiments,” or “in one implementation,” “in another implementation,” “in various implementations,” “in some implementations,” “in other implementations,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

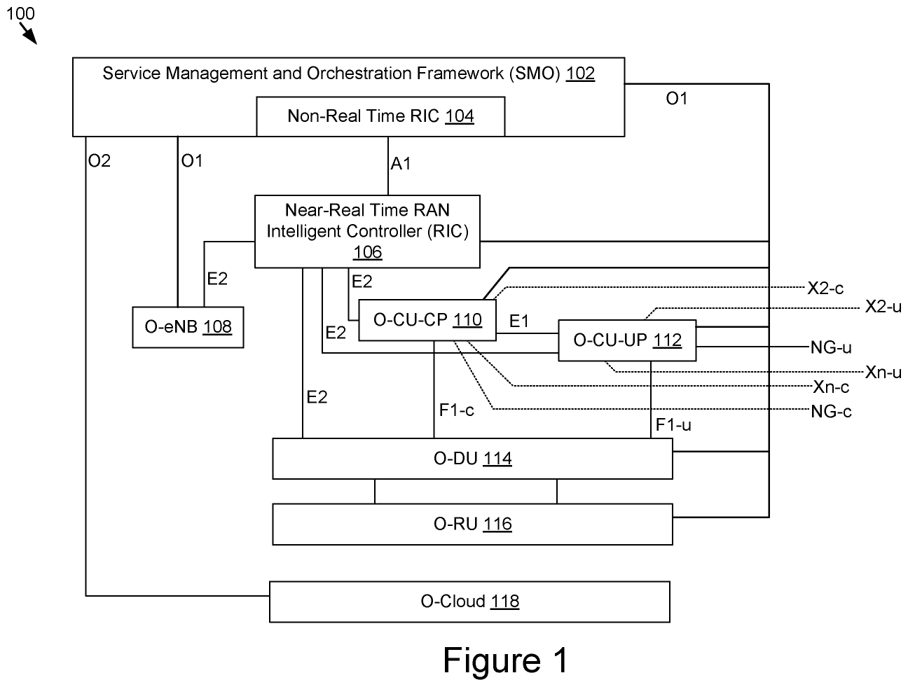

FIG. 1 shows an illustrative architecture 100 corresponding to the open radio access network (O-RAN) architecture. In this example, the open radio access network software community (O-RAN SC) architecture follows the O-RAN alliance defined architecture. O-RAN standard introduced a radio access network intelligent controller (RIC) and broke out the functionality of the RIC into non-real time actions that processed any delay tolerant actions and near-real time actions that covered any immediate actions.

Architecture 100 may include a service management and orchestration framework (SMO) 102, which may interface with other components of the architecture 100, such as, an O-Cloud 118 and a near-real time radio access network intelligent controller (RIC) 106. SMO 102 may further include a non-real time radio access network intelligent controller (RIC) 104. In some implementations, near-real time radio access network intelligent controller 106 may further communicate with an evolved NodeB (O-eNB) 108, which in some implementations corresponds to the hardware aspect of a 4G radio access network. Near-real time radio access network intelligent controller 106 also further interfaces with centralized units (CU), including a centralized unit-control plane node (O-CU-CP) 110 and a centralized unit-user plane node (O-CU-UP) 112, as well as a distributed unit (O-DU) 114, and a radio unit (O-RU) 116, as further shown in FIG. 1. Since the non-real time RIC 104 handles the delayed tolerant applications, the non-real time RIC 104 can communicate using the O1 interface in the O-RAN standard. Whereas, the near-real time RIC 106 is configured to control time sensitive applications and uses the E2 network interface for time-sensitive applications. In various embodiments, the technology of this disclosure may focus upon communications and interactions between O-DU 114, O-CU-CP 110, and/or O-CU-UP 112. FIG. 1 also further illustrates how architecture 100 may further include a multitude of communication lines interconnecting various ones of the components outlined above.

In the context of FIG. 1, radio access network (e.g., gNB or base station) disaggregation corresponds to an initial phase of the deployment of 5G technology, and a major application will be Enhanced Mobile Broadband (eMMB). Radio access network disaggregation can be performed according to the 3rd Generation Partnership Project (3GPP) or according to the O-RAN specification illustrated in the illustrative example of FIG. 1.

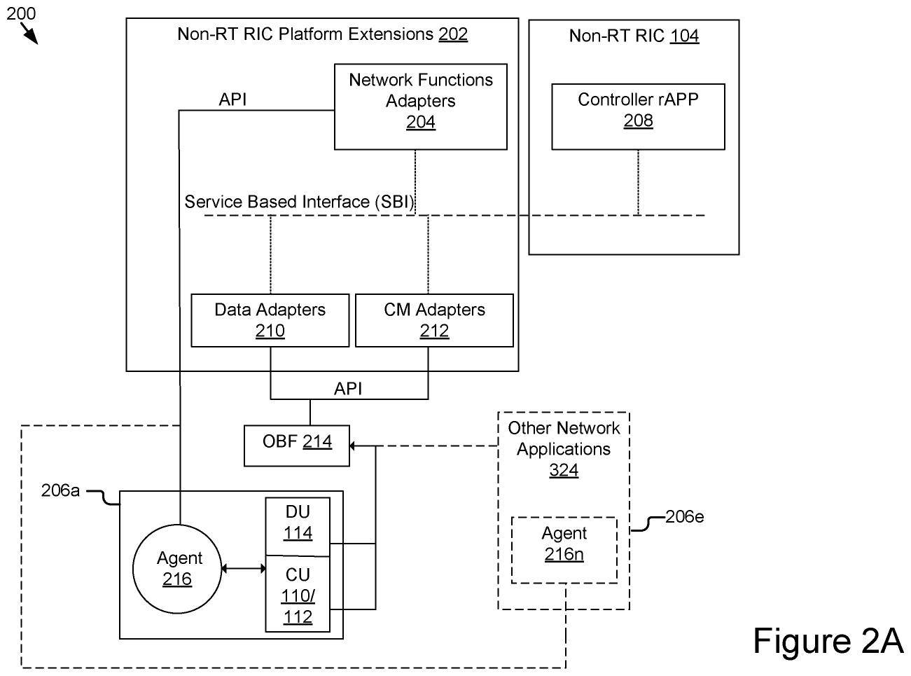

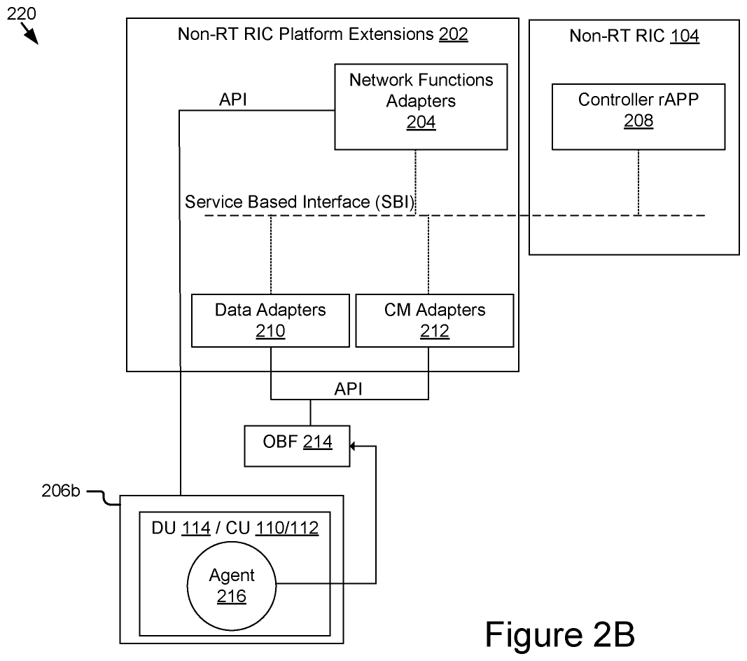

FIGS. 2A and 2B show illustrative architectures 200 and 220 respectively, of example disaggregated application 206 with a non-real time RIC 104. Architectures 200 and 220 may include a non-real time RIC 104 as described with respect to FIG. 1, which may interface with non-real time RIC platform extensions 202 that may adapt the portions of the non-real time RIC for various applications in the system 100. For example, in some implementations, the Non-RT RIC platform extensions 202 may include network function adapters 204, data adapters 210, and/or CM adapters 212. It should be understood that other adapters to expand the capabilities of the O-RAN are also contemplated and not limited to the example Non-RT RIC platform extensions 202 included herein. As shown in the architectures 200 and 220, the Non RT RIC 104 may include one or more applications inside the RIC platform, such as a plane management application, for example a PM Controller rAPP 208 that may control various applications or settings of the RAN system. The PM Controller rAPP 208 or another rAPP may interface with the one or more Non-RT RIC Platform Extensions 202 using service based interfaces (SBI) that may include various application program interfaces (API) to pass information back and forth. In some implementations, the architectures 200 and/or 220 may include one or more disaggregated applications 206 that provide functionality for altering or changing applications of the RAN system while being separate from the Non-RT RIC 104.

As shown in FIG. 2A, in some implementations, the disaggregated application 206a may include a small agent 216, such as a PM Controller that is separate from the RAN functions (e.g, the DU 114 or CU 110/112). The agent 216, such as the PM controller, may interface with the Controller rAPP 208, such as a PM Controller rApp, or other applications of the Non-RT RIC 104, such as to alter the RAN applications or configurations of the RAN functions in the architecture 100. As shown in FIG. 2A, the agent 216 is separate from the RAN functions, such as the DU 114 and/or the CU 110/112 and may provide commands that the RAN functions, such as the DU 114 and/or the CU 110/112 may use to change applications using the data lake, such as OBF 214. In some implementations, as shown in FIG. 2A, other disaggregated applications 206e may include other network applications 324 with agents 216n that interface with the controllers 208n of the Non-RT RIC 104 in order to alter the RAN applications or configurations of the RAN functions as described elsewhere herein.

For example, in one implementation, a RAN vendor may be generating a certain amount of counters, such as 600 counters that are then used to look at the data. In some implementations, the controller 208 may determine the certain amount of counters can be reduced to improve the system while preserving functionality and may send instructions to the agent 216 to only generate 100 counters and only stream those 100 counters outside to the data lake (OBF 214) and to disable the 500 remaining counters. The controller 208 is able to intelligently control the RAN function that is external to the Non-RT RIC 104 using the agent 216, such as a PM Controller, which is something that previous RAN functions were not capable of, since they did not have a disaggregated application 206 with a small agent. Furthering the example of the counters, the controller 208 may further determine that some of the data is not being read based on the currently operating counters. To determine the issue, the controller 208 may send updated instructions to the agent 216 to enable additional counters. The agent 216 may then cause the RAN functions to enable the additional counters, such as 10 additional counters, that are then included in the data lake, such as OBF 214.

As shown in FIG. 2B, in some implementations, the disaggregated application 206b may include a small agent 216, such as a PM Controller, that is installed directly within the RAN functions (e.g, the DU 114 or CU 110/112). The agent 216 may interface with the controller 208 or other applications of the Non-RT RIC 104, such as to alter the RAN applications or configurations of the RAN functions in the architecture 100. As shown in FIG. 2B, the agent 216 is within the RAN functions, such as the DU 114 and/or the CU 112 and may provide commands directly to the RAN functions, such as the DU 114 and/or the CU 110/112 that may be used to change behaviors of the RAN functions. For example, in a more time-dependent example, the controller 208 may provide instructions to the agent 216 inside of the RAN functions to change the schedule of behaviors of one or more of the RAN functions. Since these behavior schedules may be initiated in a more time sensitive situation, to change the RAN functions, the agent 216 that is located within the RAN functions is able to provide the command to affect the schedules more quickly than if the agent 216 was separate from the RAN functions as shown in FIG. 2A.

By using the disaggregated application 206, the application can be separated from the platform back to the RAN functions. Additionally, in some implementations, the controller 208 may also separately provide instructions directly to the RAN functions, DU 114 and/or CU 110/112. In further implementations, the agent 216 does not have to be an agent of the controller 208, but may instead be a separate rAPP controller that talks directly to the DU 114/CU 110/112 while also talking directly to the platform, the Non-RT RIC 104. It should be understood that in this example, the disaggregated application 206 is being described as controlling counters, but the disaggregated application 206 is also able to control other applications of the RAN functions and or configurations/settings of the RAN functions and is not limited just to the example of controlling counters. Additionally, it should be understood that the components of the examples in systems 200 and 220 are examples and other adapters or controllers could be used to perform different functions in the architecture using the Non-RT RIC 104 and the disaggregated application 206.

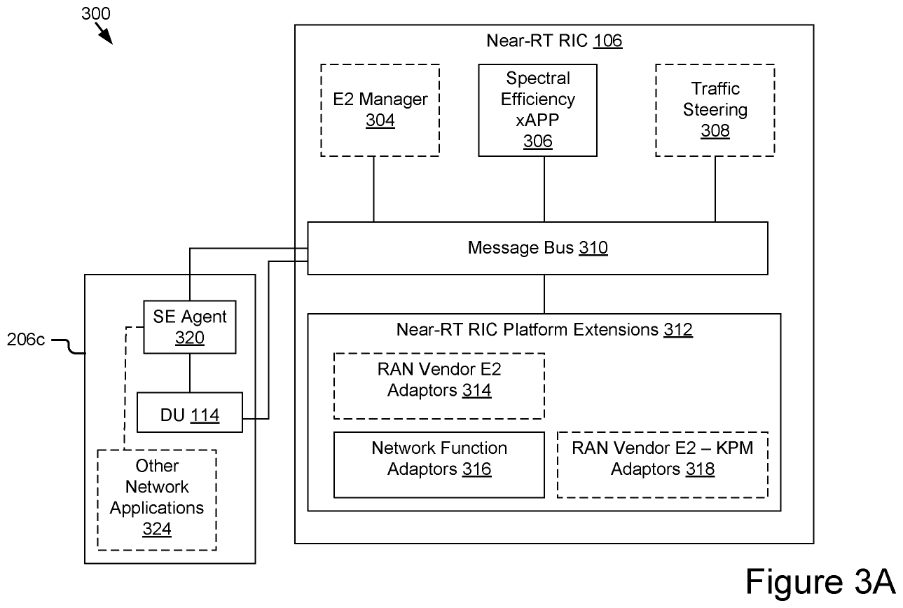

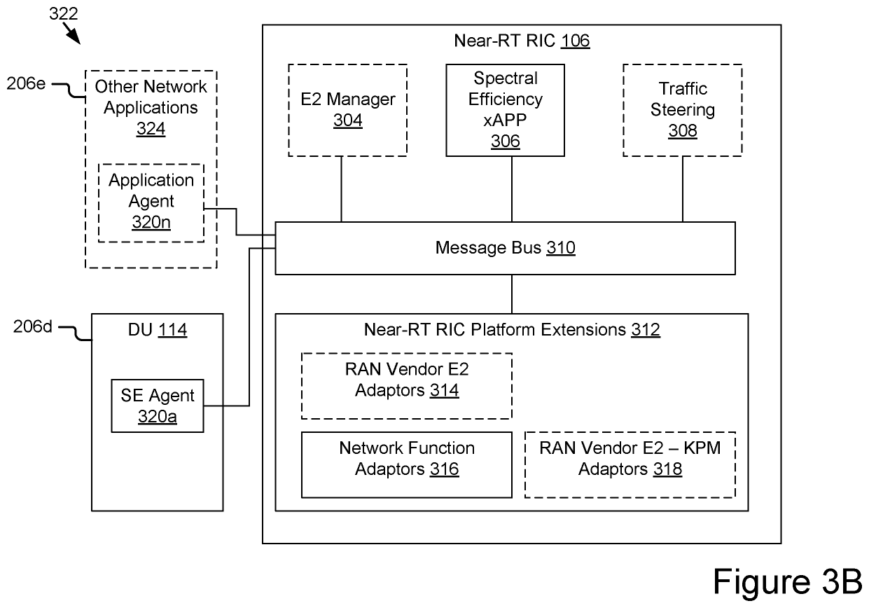

FIGS. 3A and 3B show illustrative architectures 300 and 322 respectively, of example disaggregated application 206 with a near-real time RIC 106 Architectures 300 and 322 may include a near-real time RIC 106 as described with respect to FIG. 1, which may interface with near-real time RIC platform extensions 321 that may adapt the portions of the near-real time RIC 106 for various applications in the system 100. For example, in some implementations, the Near-RT RIC platform extensions 312 may include network function adapters 316 and/or other specific adapters, such as RAN Vendor E2 Adapters 314 and/or RAN Vendor E2—KPM Adapters 318. It should be understood that other adapters to expand the capabilities of the O-RAN are also contemplated and not limited to the example Near-RT RIC platform extensions 312 included herein. As shown in the architectures 300 and 322, the Near-RT RIC 106 may include one or more applications inside the RIC platform, such as a Spectral Efficiency xAPP 306 that may control various applications or settings of the RAN system or other network application controllers that may control other settings of the RAN system and communicate with the agent 320. The Spectral Efficiency xAPP 306 (or another xAPP controller) may interface with one or more other extension applications, such as an E2 Manager 304 and/or a Traffic Steering 308 application using a message bus 310 that may include various application program interfaces (API) to pass information back and forth. In some implementations, the architectures 300 and/or 322 may include one or more disaggregated applications 206 that provide functionality for altering or changing applications of the RAN system while being separate from the Near-RT RIC 106.

As shown in FIG. 3A, in some implementations, the disaggregated application 206c may include a small agent, such as SE Agent 320 that is separate from the RAN functions (e.g, the DU 114 or CU 110/112). It should be understood that while the SE Agent 320 is shown in FIGS. 3A and 3B, any agent 320 of a controller or network application may be used in place of the SE agent 320. The SE Agent 320 may interface with the Spectral Efficiency xAPP 306 or other applications of the Near-RT RIC 106, such as to alter the RAN applications or configurations of the RAN functions in the architecture 100. As shown in FIG. 3A, the SE Agent 320 is separate from the RAN functions, such as the DU 114 and may provide commands that the RAN functions, such as the DU 114 may use to change applications. In some implementations, the agent 320 may instead interface with other network applications 324, instead of the DU 114, such as a CU 110/112, a core network function, an observability framework, an orchestration application, or another network application.

For example, in one implementation, the Near-RT RIC 106 may need to adjust a behavior of the DU 114 and the Near-RT RIC 106 may send a command to the SE Agent 320 in the disaggregated application 206c. The SE Agent 320 may then interact with the DU 114 or other RAN function to adjust the behavior of the RAN function based on the behavior change command from the xAPP 306. The xAPP 306 is able to intelligently control the RAN function that is external to the Near-RT RIC 1064 using the agent, SE Agent 320, which is something that previous RAN functions were not capable of, since they did not have a disaggregated application 206 with a small agent. The Near-RT RIC 106 may be able to use various machine learning algorithms and other information to make determinations that will improve the RAN functionality and provide those determinations to the SE Agent 320.

As shown in FIG. 3B, in some implementations, the disaggregated application 206d may include a small agent, such as SE Agent 320 that is installed directly within the RAN functions (e.g, the DU 114). The SE Agent 320 may interface with the Spectral Efficiency xAPP 306, another xAPP, or other applications of the Near-RT RIC 106, such as to alter the RAN applications or configurations of the RAN functions in the architecture 100. In some implementations, instead of interacting within the DU 114 as shown in FIG. 3B, the small agent may be an application agent 320n that is within other network applications 324 as shown by disaggregated application 206e. As shown, the small agent acting as the application agent 320n may be within other network applications 324, such as a CU 110/112, a core network function, an observability framework, an orchestration application, or another network application. As shown, in one example, in FIG. 3B, the small agent is a spectral efficiency agent (SE) Agent 320 is within the RAN functions, such as the DU 114 and/or the CU 112 and may provide commands directly to the RAN functions, such as the DU 114 and/or the CU 110/112 that may be used to change behaviors of the RAN functions. For example, in a more time-dependent example, the xAPP 306 may provide instructions to the SE Agent 320 inside of the RAN functions to change the schedule of behaviors of one or more of the RAN functions. Since these behavior schedules may be initiated in a more time sensitive situation, to change the RAN functions, the SE Agent 320 that is located within the RAN functions is able to provide the command to affect the schedules more quickly than if the SE Agent 320 was separate from the RAN functions as shown in FIG. 3A.

By using the disaggregated application 206, the application can be separated from the platform back to the RAN functions, such as the Near-RT RIC 106. Additionally, in some implementations, the xAPP 306 may also separately provide instructions directly to the RAN functions, DU 114 and/or CU 110/112. In further implementations, the SE Agent 320 does not have to be an agent of the xAPP 306, but may instead be a separate xAPP controller that talks directly to the DU 114/CU 110/112 while also talking directly to the platform, the Near-RT RIC 106. It should be understood that in this example, the disaggregated application 206 is being described as changing RAN function behaviors, but the disaggregated application 206 is also able to controlling other applications of the RAN functions and or configurations/settings of the RAN functions and is not limited just to the example of changing behaviors, such as schedules. Additionally, it should be understood that the components of the examples in systems 300 and 322 are examples and other adapters or controllers could be used to perform different functions in the architecture using the Near-RT RIC 106 and the disaggregated application 206.

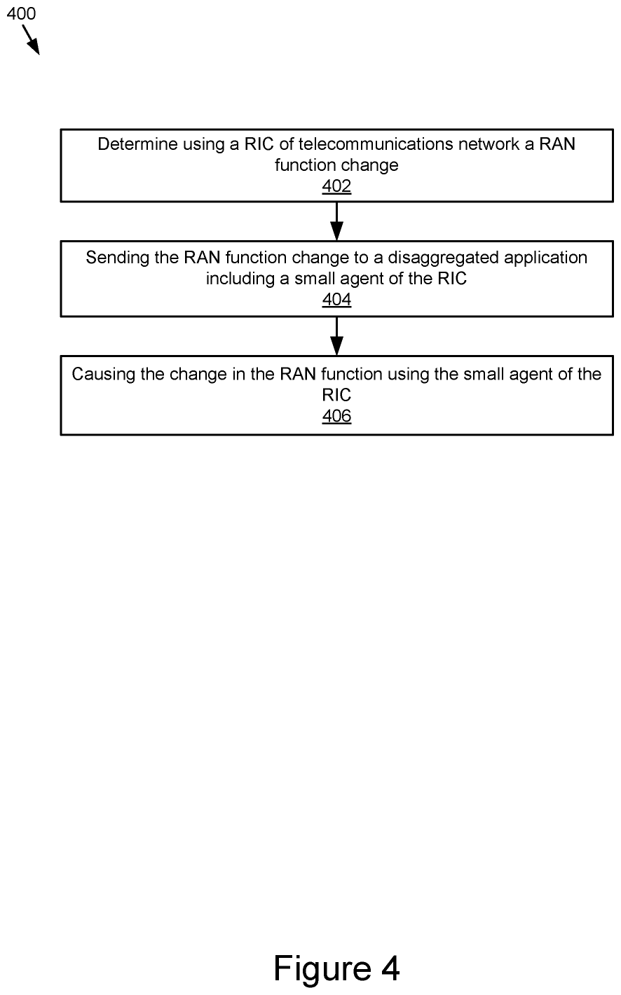

FIG. 4 shows a flowchart 400 of an example method of using a disaggregated application 206 on a RAN controlled via the RIC. At 402, the RIC, such as the Non-Real Time RIC 104 or the Near-Real Time RIC 106, of a telecommunications network, such as in system 100 of FIG. 1, may determine a RAN function change. The RAN function change may be a behavior change of the DU 114 and/or CU 110/112 that may cause an operation change in the behavior of the applications. For example, in some implementations, the RAN function change may be to change a number of counters, implement a new application, update a status change, change a schedule, etc. The RAN function change may be a change to improve an efficiency of the overall system, such as system 100. The RIC may determine the RAN function change using historical data and trends, such as from machine learning algorithms to identify areas where the RAN functions can be manipulated to improve the performance of the overall system, such as system 100. In some implementations, the RIC may use an application or controller within the RIC to determine the RAN function change. For example, the application or controller may be a specific application or controller, such as an rAPP or xAPP application that is used to determine efficiency changes or other aspects of the RAN functions.

At 404, the RIC may send the determined RAN function change to a disaggregated application 206. The disaggregated application 206 may be separate from the RIC but still able to communicate with the RIC and/or controllers/applications of the RIC. In some implementations, the disaggregated application 206 may include a small agent of the RIC. The small agent may be a portion of an rAPP or xAPP of the RIC that is separate from the RIC and instead located in the disaggregated application 206. Examples of the small agent may include the PM Controller 216 as described with respect to FIGS. 2A and 2B or the SE Agent 320 as described with respect to FIGS. 3A and 3B. In some implementations, the small agent may act as an agent of the rAPP 208 or xAPP 306, while in further implementations, the small agent may be a separate application running on the disaggregated application 206. The small agent allows the RIC or the application of the RIC to communicate directly with the disaggregated application 206 to provide RAN function changes to the small agent.

At 406, the small agent of the RIC may cause the change in the RAN function to alter a behavior of one or more of the centralized unit (CU) or distributed unit (DU). In some implementations, the small agent may be separate from the CU or the DU, while in further implementations, the small agent may be within the CU or the DU. When the small agent is within the CU or the DU, the small agent is able to enact time-sensitive behavior changes to alter the behavior of the CU or DU to improve the overall system 100. For example, the small agent may be located within the DU and may receive a RAN function to alter a behavior of the DU related to a schedule. This change may be employed by the small agent directly to the relevant function of the DU and allowing the RIC to send RAN function changes directly to the small agent that is separate from the RIC.

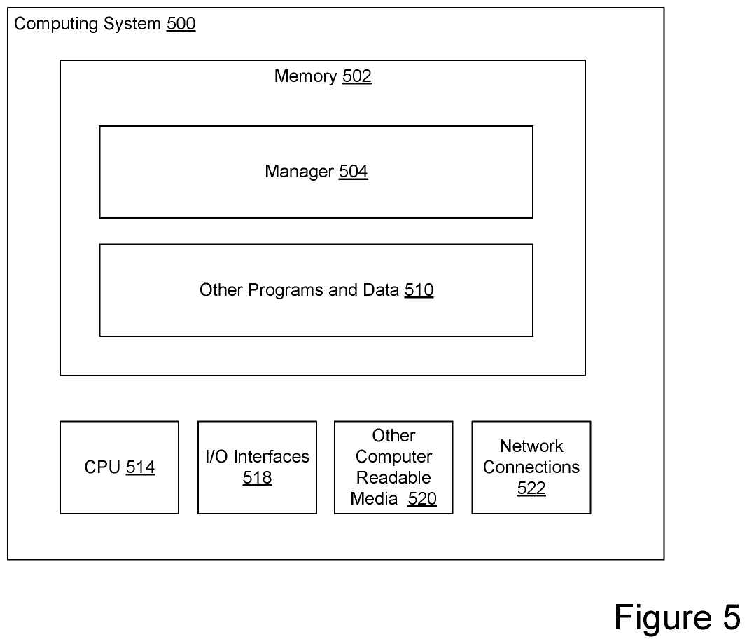

FIG. 5 shows a system diagram that illustrates an example computing system 500 that implements and/or comprises one or more components of a system that implements a disaggregated application on a RAN controlled via RIC platform as described herein.

In various embodiments, the computing system 500 can be implemented either as network elements on dedicated hardware, as a software instance running on dedicated hardware, or as a virtualized function instantiated on an appropriate platform, e.g., a cloud infrastructure. In some embodiments, many operations and functionality of such systems may be completely software-based and designed as cloud-native, meaning that they're agnostic to the underlying cloud infrastructure, allowing higher deployment agility and flexibility. Accordingly, various embodiments described herein may be implemented in software, hardware, firmware, or in some combination thereof. Computing system 500 may include memory 502, one or more central processing units (CPUs) 514, I/O interfaces 518, other computer-readable media 520, and network connections 522.

Memory 502 may include one or more various types of non-volatile and/or volatile storage technologies. Examples of memory 502 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 502 may be utilized to store information, including computer-readable instructions that are utilized by CPU 514 to perform actions, including embodiments described herein.

Memory 502 may have stored thereon access manager 504. The manager 504 is configured to implement and/or perform various control functions to implement operations of the disaggregated application of the RAN controlled via the RIC platform described herein. Memory 502 may also store other programs and data 510, which may include control systems for functionality for the cellular wireless telecommunication network, control systems for amplifying, digitizing, transmitting and receiving RF signals associated with radio towers for the cellular wireless telecommunication network, performance statistics, network interference management and statistics, quality of service management and statistics, throughput statistics, databases, user interfaces, operating systems, other network management functions, other NFs, etc.

Network connections 522 are configured to communicate with other computing devices, telecommunication equipment, computer network equipment and/or radio antennas, to perform operations of the computing system 500. In various embodiments, the network connections 522 may include transmitters and receivers to send and receive data as described herein; hardware that implements functionality of the disaggregated application of the RAN controlled via the RIC platform for the cellular wireless telecommunication network; hardware that implements systems for amplifying, digitizing, transmitting and receiving the RF signals associated with radio towers for the cellular wireless telecommunication network; radio hardware including one or more amplifiers, filters, analog-to-digital (A/D) converters, wiring, antennas and base-station towers and/or interfaces thereto; etc.

I/O interfaces 518 may include video interfaces, other data input or output interfaces, or the like. In some embodiments, I/O interfaces 518 may include transmitters and receivers to send and receive data as described herein; hardware that implements systems for functionality of the disaggregated application of the RAN controlled via the RIC platform for the cellular wireless telecommunication network; hardware that implements systems for amplifying, digitizing, transmitting and receiving the RF signals associated with radio towers for the cellular wireless telecommunication network; radio hardware including one or more amplifiers, filters, analog-to-digital (A/D) converters, wiring, antennas and base-station towers and/or interfaces thereto; etc.

Other computer-readable media 520 may include other types of stationary or removable computer-readable media, such as removable flash drives, external hard drives, or the like.

In some embodiments, one or more special-purpose computing systems may be used to implement systems of the manager 504. Accordingly, various embodiments described herein may be implemented in software, hardware, firmware, or in some combination thereof.

The various embodiments described above can be combined to provide further embodiments. These and other changes can be made to the embodiments and implementations in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
determining, by a RAN intelligent controller (RIC) of a telecommunications network, a RAN function change;
sending the RAN function change to a disaggregated application that is separate from the RIC, the disaggregated application including a small agent of an application of the RIC; and
causing by the small agent of the application of the RIC, the RAN function change to alter a behavior of one or more of a centralized unit (CU) or a distributed unit (DU).

2. The method of claim 1, wherein the RIC is a non-real time RIC and the RAN function change is a delayed tolerant function change.

3. The method of claim 2, wherein the small agent is a controller of a non-real time RIC application, and the controller is separate from the one or more of the CU or the DU.

4. The method of claim 2, wherein the small agent is a controller of a non-real time RIC application, and the controller is included within the one or more of the CU or the DU.

5. The method of claim 1, wherein the RIC as a near-real time RIC and the RAN function change is a time-sensitive function change.

6. The method of claim 5, wherein the small agent is an agent of a near-real time RIC application, and the agent is separate from the one or more of the CU or the DU.

7. The method of claim 5, wherein the small agent is an agent of a near-real time RIC application, and the agent is included within the one or more of the CU or the DU.

8. A non-transitory computer-readable medium encoding instructions that, when executed by at least one physical processor of a computing device, cause the computing device to perform a method comprising:
determining, by a RAN intelligent controller (RIC) of a telecommunications network, a RAN function change;
sending the RAN function change to a disaggregated application that is separate from the RIC, the disaggregated application including a small agent of an application of the RIC; and
causing by the small agent of the application of the RIC, the RAN function change to alter a behavior of one or more of a centralized unit (CU) or a distributed unit (DU).

9. The non-transitory computer-readable medium of claim 8, wherein the RIC is a non-real time RIC and the RAN function change is a delayed tolerant function change.

10. The non-transitory computer-readable medium of claim 9, wherein the small agent is a controller of a non-real time RIC application, and the controller is separate from the one or more of the CU or the DU.

11. The non-transitory computer-readable medium of claim 9, wherein the small agent is a controller of a non-real time RIC application, and the controller is included within the one or more of the CU or the DU.

12. The non-transitory computer-readable medium of claim 8, wherein the RIC is a near-real time RIC and the RAN function change is a time-sensitive function change.

13. The non-transitory computer-readable medium of claim 12, wherein the small agent is an agent of a near-real time RIC application, and the agent is separate from the one or more of the CU or the DU.

14. The non-transitory computer-readable medium of claim 12, wherein the small agent is an agent of a near-real time RIC application, and the agent is included within the one or more of the CU or the DU.

15. A system comprising:
a RAN intelligent controller (RIC) within a telecommunications network; and
a disaggregated application separate from the RIC within the telecommunications network;
wherein the RIC and the disaggregated application are configured to perform a method comprising:
determining, by the RIC a RAN function change;
sending the RAN function change to the disaggregated application, the disaggregated application including a small agent of an application of the RIC; and
causing by the small agent of the application of the RIC, the RAN function change to alter a behavior of one or more of a centralized unit (CU) or a distributed unit (DU).

16. The system of claim 15, wherein the RIC is a non-real time RIC and the RAN function change is a delayed tolerant function change.

17. The system of claim 16, wherein the small agent is a controller of a non-real time RIC application, and the controller is separate from the one or more of the CU or the DU.

18. The system of claim 16, wherein the small agent is a controller of a non-real time RIC application, and the controller is included within the one or more of the CU or the DU.

19. The system of claim 15, wherein the RIC is a near-real time RIC and the RAN function change is a time-sensitive function change.

20. The system of claim 15, wherein the small agent is an agent of a near-real time RIC application, and the agent is separate from the one or more of the CU or the DU.
